(19) United States
(12) Patent Application Publication
(10) Pub. No.: US 2007/0187374 A1
(43) Pub. Date: Aug. 16, 2007

(54) Titanium laser cutting with Ar/He gas mixtures

(76) Inventor: Serge Suzon, Madrid (ES)

Correspondence Address: YOUNG & THOMPSON, 745 SOUTH 23RD STREET, 2ND FLOOR, ARLINGTON, VA, 22202, US

(21) Appl. No.: 11/702,556

(22) Filed: Feb. 6, 2007

(30) Foreign Application Priority Data
Feb. 7, 2006 (EP) 06300116.8

(51) Int. Cl. B23K 26/40; B23K 26/14

(52) U.S. Cl. 219/121.72; 219/121.84

(57) ABSTRACT

A laser beam cutting process for cutting a workpiece made of titanium or a titanium alloy with the use of an assistance gas for the laser beam, characterized in that the assistance gas is an argon/helium mixture.

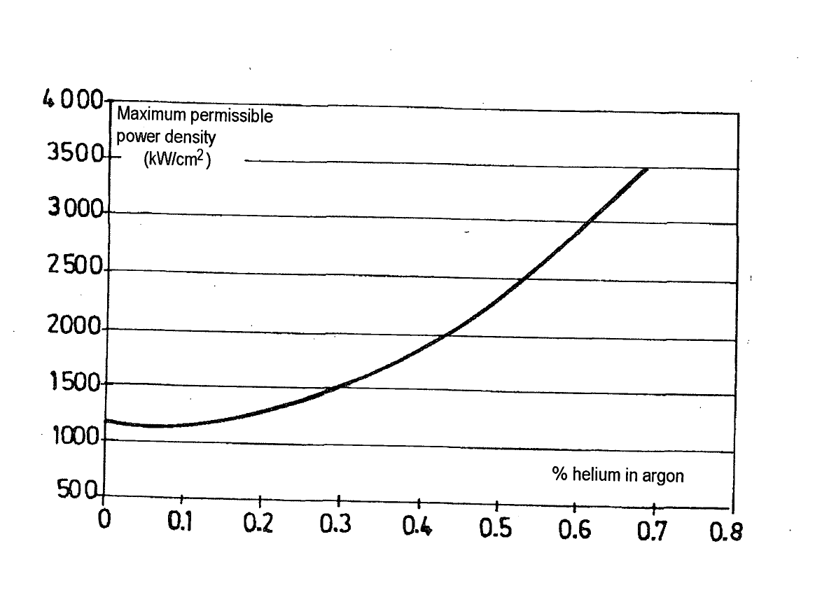

### FIELD OF THE INVENTION

The invention relates to a laser beam cutting process for cutting titanium and titanium alloys using an assistance gas formed from an argon/helium mixture.

### BACKGROUND OF THE INVENTION

Titanium and its alloys are non-ferrous metals that possess particularly useful metallurgical and mechanical characteristics, due especially to their low density, which is, for example, about 4.5 g/cm³ in the case of titanium. The properties of titanium are very desirable, in particular for high-technology applications.

Moreover, in CO₂ laser cutting with a power of at least 1.5 kW and/or a power density of at least 1 MW/cm², the high energy density of the focused laser beam tends to cause local vaporization of the material of the workpiece to be cut.

Depending on the conditions, the metal vapour is locally transformed to a plasma, which is liable to propagate into the surrounding cutting gas. The metal and gas plasmas can then absorb some of the incident energy that gives rise to a power shortfall in the cutting kerf. This inevitably leads to the formation of cutting defects, especially burrs on the lower face of the cutting kerf.

Consequently, any condition promoting the formation of a plasma is considered to be a limiting factor in the laser cutting process, especially in terms of cutting speed and regulating flexibility.

Moreover, titanium and titanium alloys have a high sensitivity to oxygen (oxidation, combustion) and to nitrogen (nitriding).

To avoid such problems, argon is only used for cutting titanium and its alloys by thermal cutting.

However, argon is a gas that ionizes easily, having an ionization potential of about 15.4 eV. In other words, it constitutes a limiting factor in the laser cutting process as it ionizes very rapidly and, therefore, disturbs the cutting process.

Consequently, it is ineffective to have high-power (>1.5 kW and/or 1 MW/cm²) laser cutting with a CO₂ source, operating at a wavelength of about 10.6 μm, using argon as an assistance gas (i.e., cutting gas) for the laser beam.

It has already been proposed to replace argon with helium, since far more energy is required to ionize helium than to ionize argon, namely about 24.5 eV.

The use of helium as cutting gas may, therefore, be effective, but on the condition that large flow rates are used. This is because the helium molecule is small, and the dynamic impact of the gas in the cutting kerf for standard gas flow rates is very slight.

Thus, cutting under helium with a very high flow rate allows the effective kinetic conditions of the cutting jet to be maintained.

However, to increase the helium flow rate is economically detrimental to the process due to the high cost of helium, leading many users to reject this solution.

As a result, the problem that arises is to provide a laser cutting process for titanium and titanium alloys that does not have the above-mentioned problems and drawbacks, especially a process that results in effective cutting of a workpiece made of titanium or a titanium alloy, i.e., with or without minimal burring and at a cutting speed compatible with use on an industrial scale, for example, a speed of at least 3 to 4 m/min for a thickness of 2.5 mm, and that is economically acceptable to the user.

### SUMMARY OF THE INVENTION

The solution of the invention is a laser beam cutting process for cutting a workpiece made of titanium or a titanium alloy with the use of an assistance gas for the laser beam, wherein the assistance gas is an argon/helium mixture.

The process of the invention may include one or more of the following features:

the laser is obtained by means of a laser generator of the CO₂, Nd:YAG, diode or fibre type;

the gas mixture contains 20 to 80% argon by volume and/or the gas mixture contains 20 to 80% helium by volume;

the gas mixture contains 30 to 70% argon by volume and/or the gas mixture contains 30 to 70% helium by volume;

the gas mixture is formed only from argon and helium;

the gas mixture consists of 40 to 60% argon by volume, the remainder being helium.

the gas mixture consists of 50% argon and 50% helium;

the laser beam has a power of at least 1 kW, preferably from 1.5 to 20 kW;

the workpiece to be cut is a plate having a thickness of between 0.5 mm and 4 mm, preferably at least 1 mm;

the cutting speed is at least 2 m/min, preferably between 3 and 10 m/min;

the laser beam is generated by a CO₂ laser source or an ytterbium fibre laser source; and

the pressure of the cutting gas is between 5 bar and 20 bar and/or the flow rate of the cutting gas is between 5 and 75 m³/h.

The argon/helium gas mixture may be premixed before it is introduced into the cutting head, or the mixture may be produced in situ by mixing one gas with the other, in the cutting head or as it leaves the latter, for example, via a dual gas flow, the gases of which are distributed concentrically, one with respect to the other, before being mixed in the required proportions to obtain the desired He/Ar mixture. In the latter case, the two gases that are mixed together may be “pure” gases, for example, argon and helium, or Ar/He gas mixtures of the same composition or different compositions, which are mixed in the cutting head or upon leaving the latter.

A principle of the invention is, therefore, to increase the ionization potential of the cutting gas using an argon/helium mixture as an assistance gas for high-power CO₂ laser cutting. The addition of helium to the assistance gas tends to reduce the ionization potential of the gas, while maintaining the dynamic potential of the cutting gas jet.

The invention may be applied to any other type of laser source that is liable to create an undesirable plasma in the cutting gas. However, it has been noticed that during comparative laser cutting trials on titanium with helium and with argon, that what limits the cutting speed with the helium is the appearance of small burrs at the bottom of the cutting kerf that result from too high a cutting speed, whereas in the presence of argon, cutting defects result essentially from the appearance of a plasma in the cutting kerf.

Moreover, it is necessary to use helium flow rates three times higher than those used with argon.

It was deduced from the foregoing that an assistance gas containing 100% helium by volume is unnecessary, and an argon/helium mixture may be sufficient to eliminate or minimize the appearance of a plasma at the optimum cutting speed, namely, the maximum possible speed for obtaining a burr-free cutting of titanium.

The argon/helium mixture must be chosen according to the cutting conditions such as the laser power and geometry of the workpiece to be cut. The choice may be made empirically by the user.

In all cases, using an argon/helium mixture to cut titanium or a titanium alloy according to the invention makes it possible to benefit from the advantages of both helium and argon, but without the drawbacks encountered when these gases are used alone.

To confirm these observations, the inventor of the present invention carried out the comparative trials discussed below.

### BRIEF DESCRIPTION OF THE DRAWINGS

The appended FIGURE shows the maximum permissible power density obtained during the comparative trials as a function of helium content in the Ar/He gas mixture.

### DETAILED DESCRIPTION OF THE INVENTION

The purpose of the comparative trials was to determine the maximum permissible power for the cutting kerf and the corresponding cutting speed for various argon/helium mixtures, and pure argon as a comparison, according to required quality criteria, such as roughness, fine burrs, loss of cut or poor-quality cut owing to burning, appearance of a plasma in the shielding gas, etc.

The cutting trials were carried out with a 3 kW CO₂ laser device from Trumpf, on a titanium plate 2.5 mm in thickness, using four different (in vol %) cutting gases, namely:

Trial A: pure argon

Trial B: 70% Ar/30% He mixture

Trial C: 50% Ar/50% He mixture and

Trial D: 30% Ar/70% He mixture.

Other trial conditions and the results obtained are given in Tables 1 and 2 below:

TABLE 1

| Trial conditions | Trial A | Trial B | Trial C | Trial D |
|---|---|---|---|---|
| Power (W) | 810 | 1080 | 1260 | 2565 |
| Measured power | 1147 | 1530 | 2294 | 3633 |
| density (kW/cm²) | | | | |
| Cutting speed | 1.6 | 2.2 | 3.3 | 5.2 |
| (m/min) | | | | |
| Focal point (mm) | 4 | | | |
| Pressure (bar) | 12 | | | |
| Nozzle diameter | 1.4 | | | |
| (mm) | | | | |
| Gas flow rate | 12 | 20 | 25 | 30 |
| (m³/h) | | | | |
| Gas consumption per | 125 | 150 | 126 | 96 |
| cut metre (l/m) | | | | |

As can be seen, the trials demonstrate that by increasing the proportion of helium, it is possible to increase the power permitted by the workpiece, resulting in a higher cutting speed. This increase makes it possible, above 50% helium by volume, to reduce the consumption of assistance gas per linear metre. Compared with argon, regulating flexibility occurs as soon as 30% helium by volume is introduced. Finally, a power and cutting speed limit of 70% helium is reached because of fine burrs. This emphasizes the effect of a slight excess of helium.

It, therefore, clearly follows from these trials that the use of helium/argon mixtures makes it possible to benefit from the advantages of both helium and argon. In this regard, regulating flexibility occurs as soon as 30% helium is introduced, and maximum power is reached for a helium content of about 70% helium by volume.

In addition, the use of Ar/He mixtures according to the invention results in a reduction in plasma formation, an increase in cutting speed, a reduction in the amount of helium used and, as a result, a reduction in the flow rate of assistance gas.

Table 2 below gives the maximum cutting speed and the percentage (%) of the maximum laser power above which a deleterious plasma forms in the cutting gas for the four mixtures A to D tested.

TABLE 2

| | | Percentage of the maximum |
|---|---|---|
| | Cutting speed | laser power |
| Trial | (m/min) | (%) |
| A | 1.8 | 35 |
| B | 2.45 | 50 |
| C | 3.6 | 65 |
| D | 5.2 | 100 |

This shows that with pure argon (Trial A), a cutting speed of 1.8 m/min cannot be exceeded, whereas with the mixtures according to the invention, it is possible to increase not only the cutting speed but also the useful laser power.

1. Laser beam cutting process for cutting a workpiece made of titanium or a titanium alloy with the use of an assistance gas for the laser beam, characterized in that said assistance gas is an argon/helium mixture.

2. Process according to claim 1, characterized in that the laser beam is obtained by means of a laser generator of the CO₂, Nd:YAG, diode or fibre type.

3. Process according to claim 1, characterized in that the gas mixture contains 20 to 80% argon by volume and/or the gas mixture contains 20 to 80% helium by volume.

4. Process according to claim 1, characterized in that the gas mixture contains 30 to 70% argon by volume and/or the gas mixture contains 30 to 70% helium by volume.

5. Process according to claim 1, characterized in that the gas mixture is formed only from argon and helium.

6. Process according to, characterized in that the gas mixture consists of 40 to 60% argon by volume, the remainder being helium.

7. Process according to claim 1, characterized in that the gas mixture consists of 50% argon and 50% helium.

8. Process according to claim 1, characterized in that the laser beam has a power of at least 1 kW, preferably from 1.5 to 20 kW.

9. Process according to claim 1, characterized in that the workpiece to be cut is a plate having a thickness of between 0.5 mm and 4 mm, preferably at least 1 mm.

10. Process according to claim 1, characterized in that the cutting speed is at least 2 m/min, preferably between 3 and 10 m/min.

11. Process according to claim 1, characterized in that the laser beam is generated by a CO₂ laser source or an ytterbium fibre laser source.

12. Process according to claim 1, characterized in that the pressure of the cutting gas is between 5 bar and 20 bar and/or the flow rate of the cutting gas is between 5 and 75 m³/h.

13. Process according to claim 2, characterized in that the gas mixture contains 20 to 80% argon by volume and/or the gas mixture contains 20 to 80% helium by volume.

14. Process according to claim 2, characterized in that the gas mixture contains 30 to 70% argon by volume and/or the gas mixture contains 30 to 70% helium by volume.

15. Process according to claim 2, characterized in that the gas mixture is formed only from argon and helium.
